(19) United States
(12) Patent Application Publication
(10) Pub. No.: US 2016/0140229 A1
(43) Pub. Date: May 19, 2016

(54) METHOD AND SYSTEM FOR ORGANIZING, SEARCHING, FINDING, AND FILTERING INTERNET CONTENT BASED ON CONTENT RELEVANCY THROUGH DATA CATEGORIZATION LIVE AND IN REAL TIME, WITHOUT TIME DELAY

(71) Applicant: SHUCCLE AG, REINBEK (DE)

(72) Inventor: HANS DIEDRICH KREFT, DASSENDORF (DE)

(73) Assignee: SHUCCLE AG, REINBEK (DE)

(21) Appl. No.: 14/541,851

(22) Filed: Nov. 14, 2014

(51) Int. Cl. G06F 17/30; H04L 29/08

(52) U.S. Cl. CPC G06F 17/30864; H04L 67/02; G06F 17/30887; G06F 17/30867; G06F 17/3053

(57) ABSTRACT

A method and system for organizing, searching/finding and filtering internet content based on content relevancy through data categorization by use of metadata. The present invention furthermore describes the presentation and feed of live data content to a search engine. An infrastructure of interconnected servers hosting a software to organize data, called web operating kernel (WOK), allows users to supply smart data (metadata) to describe original web content. Smart data consist of a title, description of content and its context, location or URL of the original underlying content and may include additional file attachment such as image files, audio and video files etc. This data is used by the WOKs integrated search engine software to search and find the most relevant content pertaining to a particular search term. As a results, the preferred embodiment of the present invention described how humans add information to content as opposed to the conventional search engine practice of computer algorithms extracting information from existing content to form metadata.

### TECHNICAL FIELD

The present invention relates to a method and system for organizing, searching and finding content relevant data in the web live, therefore, instantaneously and without time delay.

### BACKGROUND OF THE INVENTION

### Problem Statement

With the explosion of the internet since the mid-nineties, the number of active websites in the World Wide Web has increased to over half a billion today. To navigate the vast information available on the web, search engines offer an indispensable tool for finding applicable content to what a user is searching for. Conventional search engines like Google, Bing, Yahoo, etc. rely on web crawlers that browse the web and create a copy of specific data of the webpages they visit. These specific data are indexed and combined with the URL of the webpages visited and later used as a database (repository) for searches. While the web crawler based method provides great efficiency in scrutinizing vast amounts of data, the method does not yield a high degree of accuracy and effectiveness in returning content relevant search results in a timely fashion. Namely three specific issues arise:
1. Since web crawlers are driven by computer logarithms, the information gathered by the crawler is only the computer software's best guess as to what the content of the website relates to. Particularly, algorithms extract information from existing data to compile metadata while humans add information to content. Computers therefore lack the human power to interpret meaning of content accurately in a variety of contexts. For example, the word “current” may be assigned several meanings based on the context it is used in ranging from electric current to the flow of water. While the context a term is used in may be ambiguous to a computer, the human brain understands the specific meaning of a term through the context it is used in.
2. Web crawlers roam and collect information on the web periodically. Since it is technically impossible to simultaneously scan and rescan all information on the web in real time, the repository created by the crawler does, for the most part, not contain live information. If, for instance, new content is provided on a website, it will not be reflected in the search results of a search engine immediately but with a delay of up to several days. Conventional search engines based on a web crawler method are therefore ineffective in providing accurate search results for time sensitive information.
3. Leading conventional search engines like Google, Bing, Yahoo, etc. rely on advertising revenues. The search results returned for a search are sorted not necessarily by relevance to a specific search term but dictated by revenue generating criteria. Paid links are generally displayed and ranked higher than non-paid links. Users are thus unable to re-sort search results to filter out information less pertinent to the user's search terms.

The above issues illustrate that there is a lack of a universal system for organizing content in the web that meets web user needs. To address this issue, mainly two distinct solution attempts have been suggested. One is presented by a collaborative movement (the Dublin Core Metadata Initiative: DCMI) led by the main international standards organization for the world wide web, the World Wide Web Consortium (W3C). The other follows the intention of the market main players (Google, Amazon, Microsoft, Apple etc.) to compile personal data of web users. This data is used to present web content that best corresponds to the stored user data.

The aim of the DCMI is to organize data in a semantic web in which data is classified in topic categories and described by a standard based on a common framework. The DCMI literature became the de facto standard used for the discussion of how content could be categorized by metadata through computer intelligence. However, to date, no feasible mechanism for implementing the concept of semantically organizing data in the web on a universal and suitable scale exists in the market.

Alternatively the market main players assemble user profiles (personal data and behavior of web users) on a large scale to present content that relates to the assembled data. For example: A user of a service is recognized through the data set stored about the user and is presented with the specific service that fits to their data profile.

Both solution attempts described above rely on computer processes to organize and decide what data to present to a user. However, both attempts (categorization, user profiles) are not based on the specific human ability to describe content by metadata. If, for example, a person is describing an object another person is looking to find and where it may be found, they will use metadata to describe the non-visible object. Similarly, the same case can be made for a supplier of a specific product or service. The product or service supplier describes their product or service by its metadata in the web. The potential customer interprets the metadata and decides whether or not to respond to the offering. Both example show that humans interact informal and are able to optimize that interaction by improving their metadata (describing their intention). If, as in the first case, the object is not found, both parties will communicate and continually adapt the metadata until the second person is able to find the object. Similarly, if, in the second case of the product/service supplier, no customer is willing to engage the offer, the supplier will adapt the metadata to more fittingly describe their offering. In short, human communication relies on a strong interrelationship between the human intelligence of individuals which is not reflected in present methods used for organizing and finding content in the web.

Furthermore, neither of the aforementioned solution attempts resolve the issue of providing accurate results for time sensitive web content and information.

### Solution to the Problem

The present invention resolves the above mentioned issues and provides a solution for:
1. effectively organizing web content and information to return content relevant and accurate search results,
2. finding time sensitive web content live and in real time,
3. the ability for users to independently sort search results based their criteria to receive the most relevant search results.

An infrastructure of servers hosting software and interconnected through the internet, called Web Operating System (WOS), stores information to describe content in the web. This information is provided by the original content provider and is called smart data (metadata). It includes a description of the content and its context, keywords, the location or URL of the underlying content and may include audio, video, picture or other additional file attachments. Software on the interconnected individual servers that store the metadata coordinates the organization of the information. This software is called Web Operating Kernel (WOK). In particular: A content provider enters metadata pertinent to the content they provide through a (WOK). This information is shared instantaneously with the WOKs on all other connected servers. Particularly, a copy of the compiled metadata (smart data) is sent to and stored locally on all interconnected servers. A search engine software is incorporated with the WOKs. A user looking to find particular content may call the search engine software of any of the WOKs through their unique IP address. After initiating the search for the desired content, the local WOK searches for metadata previously stored on its local server matching or relating to the search term. The information for all relevant data from every connected WOK is thus available on all connected servers locally. By distributing metadata to all connected WOKs as it is entered by users shortens average search times to a mere 0.3 seconds.

Since all WOKs are interconnected and communicate with each other, metadata altered and or entered through any connected WOK is instantaneously shared throughout the infrastructure of servers hosting the WOKs. Information is thus accessible through the search engine software immediately, therefore, live and in real time. The time delay for updated or new web content to appear in search results, as the case with web crawlers, is thus eliminated.

Secondly, since humans describe the content with metadata, the WOKs integrated search engine returns highly accurate and content relevant search results. By categorizing content through a title, keywords and content description, there is no ambiguity for context misinterpretation as the case with conventional search engines where software employs a best guess approach in deciphers context of content.

Thirdly, search results through the WOK system are individually sortable by the user based on relevancy criteria. Filtering search results presents the user only the most relevant content pertaining to the search term. Since conventional search engines rely on paid links to create revenue, these links usually appear towards the top of the search results. This does not, however, always result in the most relevant content to appear on the top of the search results list.

### SUMMARY OF THE INVENTION

The present invention provides a method and system for organizing, searching/finding and filtering internet content based on content relevancy through data categorization live and in real time, without time delay. One embodiment of the present invention provides a method to describe web content with smart data through a graphic user interface (GUI). Smart data (metadata) consists of a title, description of content and its context, location or URL of the original underlying content and may include additional file attachment such as image files, audio and video files etc. This data is stored on servers hosting software to manage and organize data between connected servers called Web Operating Kernel. Particularly, metadata submitted by a user by accessing the server's WOK through their browser, are stored on the server locally. The WOK transmits this stored metadata to all other globally distributed servers that also host WOKs. This metadata is then stored on all other globally distributed servers. Metadata is thus locally accessible on any server locally for users accessing their respective WOK via their browser.

While this method provides a system for categorizing content into topic or category groups to provide more content relevant search results in searches for content on the web, it also ensures data is transmitted and stored locally on globally distributed servers.

Another embodiment of the present invention provides a method to sort search results to narrow search results for the content's context relevancy. This method includes the tools to filter search results through a GUI. In particular, search results may be filtered by but are not limited to date, topic group, smart data, alphabetically, etc. If, for instance, a user searched the term “current”, the user is able to narrow the search results with the filters to the context the search term applies to, be it electrical or water flow etc.

Another embodiment of the present invention provides a method to reflect new content or updates to existing content in search results immediately and without time delay. This method includes the exchange and synchronization of smart data (metadata) between interconnected servers hosting the WOKs. In particular, information provided by a content provider of time sensitive data will be visible in a user's search results immediately, the moment this data is provided. If for instance, a content providers offers last minute deals for concert tickets the day of the concert, their updated offers will be visible to users using search terms pertaining to that content immediately. Particularly, as metadata is submitted through a local server's WOK, stored on the server and instantaneously transmitted to and stored on all other globally distributed servers, the metadata is available locally on any of the servers of the infrastructure connected through the internet. If, for instance, metadata is submitted to server number 1 of a system of 500 servers, the same data is transmitted to all other 499 connected servers in the system immediately. If a user accesses any of the WOKs through their browser to find particular metadata pertaining to content they are searching for, the technical limitations of time from when the request was initiated to the time the results are displayed is minimized. As such, the WOK concept offers an alternative to cloud computing concepts where data is stored not locally but in remote server farms in an effort to reduce the time span between searching and finding the data. This is, for example, the case with conventional search engines that search indexed repositories for matches to a user's search request as opposed to sending a request to many geographically distributed servers which may, depending on the number of servers searched, result in a significant time delay.

### BRIEF DESCRIPTION OF THE DRAWINGS

FIG. 1 illustrates an example infrastructure to organize data in one embodiment of the present invention.

FIG. 2 illustrates an example flow of data between interconnected servers in the preferred embodiment of the present invention.

FIG. 3 illustrates how users submit metadata to describe and identify web content in one embodiment of the present invention.

FIG. 4 illustrates how users filter/sort and rank search results to organize content by relevancy to search terms in one embodiment of the present invention.

### DETAILED DESCRIPTION OF THE INVENTION

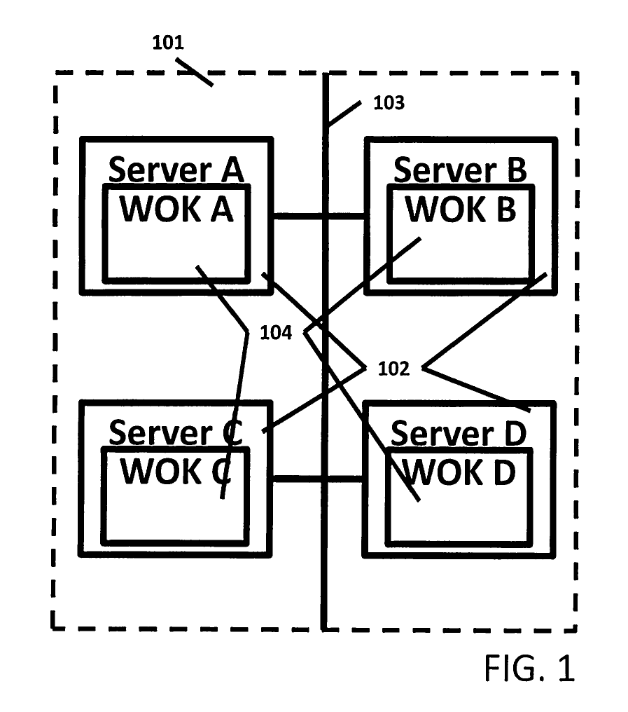

FIG. 1 illustrates an example infrastructure 101 of interconnected servers 102, connected through the internet 103, hosting software, called Web Operating Kernel (WOK) 104, to organize data. This software governs the communication and exchange of data between connected servers through the internet 103. It also allows humans to enter and edit data to describe web content, so called metadata (also called Smart-Data), through a graphic user interface. More particularly, a user enters metadata to categorize their web content to aid other users in finding the content they are looking for in the appropriate context and to make their content found more easily. Metadata may be entered through any of the connected servers 102 and the respective WOKs 104 and is transmitted to and stored on each individual server locally.

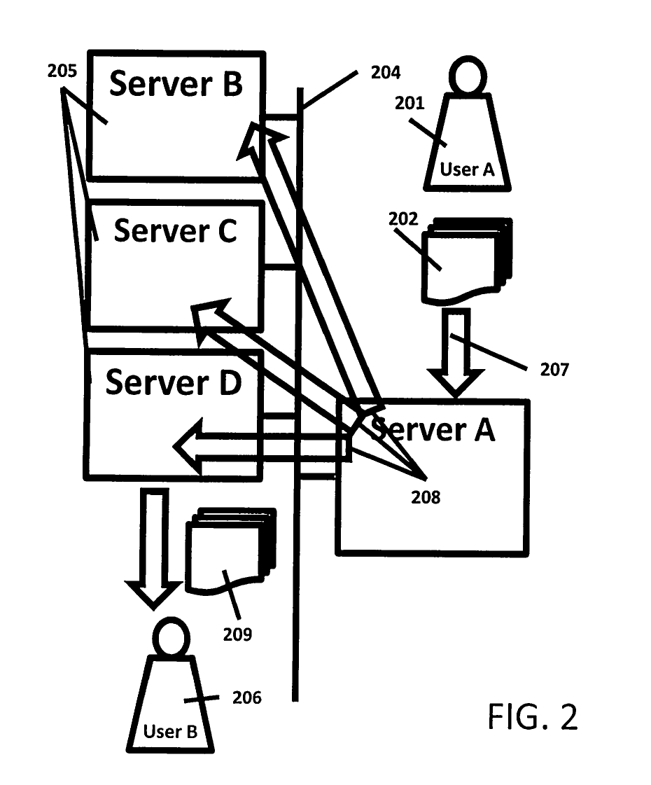

FIG. 2 illustrates the preferred embodiment of the present invention and represents the flow of data between servers managed by the WOKs. User A 201 enters metadata 202 via a graphic user interface accessed through a computer via any of the connected servers within the infrastructure (Server A in the FIG. 2) 203. The metadata is stored 207 on the local server the user has chosen to access to submit their metadata 203. The server's WOK then transmits 208 the data to all other globally distributed servers through the internet 204 instantaneously. In particular, the moment the metadata is stored on the local server, it is transmitted to all the global servers and a copy of this metadata is stored on all connected servers. The metadata 202 submitted by User A 201 on Server A 203 is now accessible through any of the connected servers 205. In particular, User B 206, who may enter a search term pertaining to the metadata relevant to the content they search for through the WOKs integrated search engine software will be presented a copy of User A's 201 metadata 209. The metadata 202 initially submitted by the local User A 201 is stored at all other (global) servers 205 immediately the instant User A 201 completed the input of his metadata. The metadata 202 is thus accessible at any other connected server instantaneously with only the common delay due to technical limitations which are usual for transmitting (usually by fiber optic cable) data between servers. Data is transmitted between servers through conventional and standardized internet protocols.

One skilled in the art will appreciate that the infrastructure can be used in various configurations where servers, technical devices and connections between them can be added, removed and rearranged. Similarly, users must not be directly connected to a specific server within the infrastructure but can also remotely connect to a server hosting the WOK through the Internet.

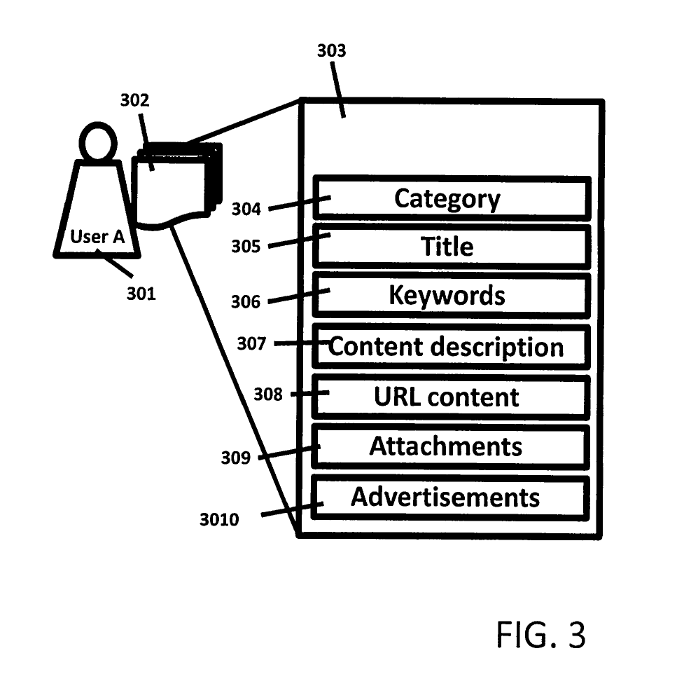

FIG. 3 illustrates how users assign metadata to web content in one embodiment of the present invention. User A 301 uses any of the connected servers' WOKs (as illustrated in FIG. 1) to describe their original web content 302 with metadata 303. The metadata 303 consists of the following elements but is not limited to: a category 304 to match content to a particular topic group. A title 305 for the content, keywords 306 pertaining to the content, a content description 307 to aid in establishing context of the content, the unique location of where the original content is located (a link to the original content or URL) 308 and additional file attachments that may include image, audio, video files etc. Additionally metadata may include advertising information 3010. The metadata 303 is then stored and shared and made accessible throughout the infrastructure of connected servers as illustrated and described in FIG. 2.

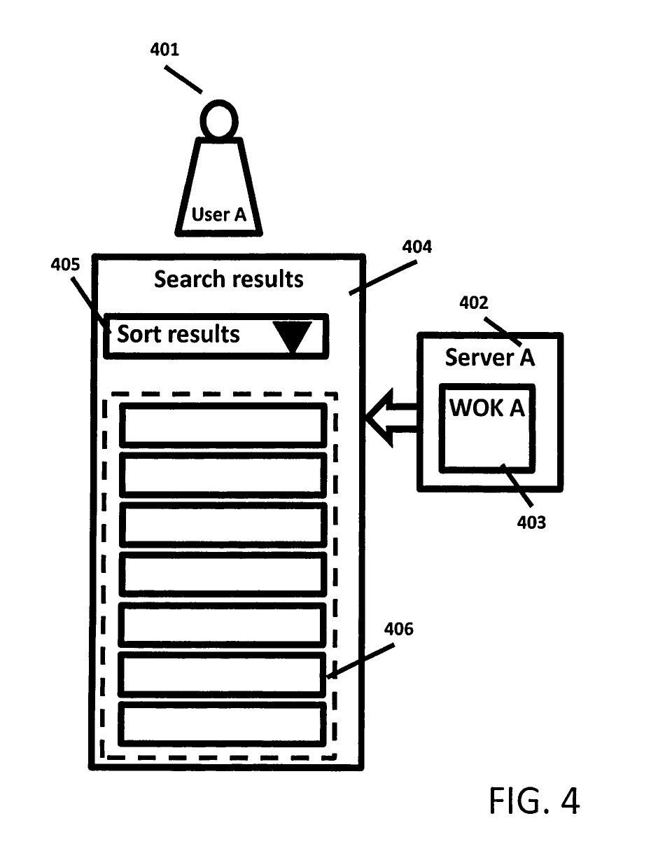

FIG. 4 illustrates how users may sort search results in the search results list in one embodiment of the present invention. User A 401 accesses Server A's 402 WOK software 403 to access the WOKs' integrated search engine function. After User A 401 initiated a search command for a search term, he is then presented a search results lists 406 pertaining to their search term in a browser window 404. The browser window includes a button to sort, as illustrated by a drop down menu button 405 in FIG. 4. The drop down list offers criteria by which User A 401 may sort/re arrange search results by. This may include, but is not limited to, a date filter, to display newest content towards the top of the search results list 406. It may furthermore include a filter to sort by content description of other metadata, an alphabetical filter, etc. By selecting the desired criteria, User A 401 commands the WOK 403 to rearrange search results 406 to better match their search criteria and find relevant content quicker.

The scope of the present invention is defined by the claims that follow.

### REFERENCES

U.S. Patent Documents

| | | |
|---|---|---|
| 20,140,222,592 A1 | January 2013 | Kreft |

Foreign German Patent Dcouments

| | | |
|---|---|---|
| DE 10 2012 005 065.8 | March 2012 | Kreft |
| DE 10 2012 005 160.3 | March 2012 | Kreft |
| DE 10 2012 009 489.2 | May 2012 | Kreft |
| DE 10 2012 009 490.6 | May 2012 | Kreft |
| DE 10 2012 013 586.6 | July 2012 | Kreft |
| DE 10 2012 014 264.1 | July 2012 | Kreft |
| DE10 2012 016 343.6 | August 2012 | Kreft |
| DE 10 2012 016 599.4 | August 2012 | Kreft |
| DE 10 2012 019 214.2 | October 2012 | Kreft |
| DE 10 2012 019 213.4 | October 2012 | Kreft |
| DE 10 2012 020 951.7 | October 2012 | Kreft |

We claim:

1. A method and system for users to store metadata by use of a browser connected to a local server
whereby the server hosts a software called Web Operating Kernel, through which users communicate and submit data
Whereby users supply metadata consisting of the following elements to the WOK:
a topic category, title, content description, location of original content (URL), keywords and additional file attachments that may include advertisements
whereby the WOK stores this data on its local server
whereby the WOK transmits the stored data via the internet to other globally distributed servers connected to the infrastructure
whereby the other servers may be located in different geographic areas
whereby the globally distributed other servers of the infrastructure also host WOKs
whereby the metadata submitted to the local WOK are available on the globally distributed servers, so that users can access metadata on any WOK through their browser locally on the particular server they chose to access

2. A method of claim 1
whereby any global server with its WOK acts as a an individual local server, so that metadata submitted through any of the servers are made available,
so that users communicating with any of the WOKs through their browser have local access to the metadata.

3. A method of claim 1
whereby the time span from beginning of a request for search results to the moment the metadata are being presented to the user are limited only by the technical limitations of the specific server the user choses to access through their browser.

4. A method of claim 1
providing a means for users to assign metadata describing original web content through a graphic user interface

5. A method of claim 1
wherein the metadata entered may be stored on any server within the infrastructure

6. A method of claim 1
wherein software to organize data hosted on servers communicates metadata entries and or alterations to existing metadata stored on any server within the infrastructure to other connected servers and their software

7. A method of claim 4
wherein new metadata or changes to existing metadata made through one individual server's software are communicated and stored on all other connected servers live, the instant metadata entries are submitted

8. A method of claim 4
wherein individual servers' software receives and stores the unique location of metadata entries or alterations thereto to reduce search times

9. A method of claim 1
wherein individual users sort and filter data to better match and rank relevant content, as it pertains to a particular search term, displayed in search results to relevant search terms
